(19) United States
(12) Patent Application Publication
(10) Pub. No.: US 2002/0125778 A1
(43) Pub. Date: Sep. 12, 2002

(54) Motor

(75) Inventor: Rikuro Obara, Nagano-ken (JP)

Correspondence Address: ISRAEL GOPSTEIN, Esq., Suite 200C, 14301 Layhill Rd., P.O. Box 9303, Silver Spring, MD, 20916-9303, US

(73) Assignee: Minebea Kabushiki-kaisha

(21) Appl. No.: 10/092,476

(22) Filed: Mar. 8, 2002

(30) Foreign Application Priority Data
Mar. 9, 2001 (JP) 2001-067496

(51) Int. Cl. H02K 5/16

(52) U.S. Cl. 310/90

(57) ABSTRACT

A motor of long life and high precision in its rotation wherein the variation on the rotation and the noises generated thereby are suppressed by maintaining the radial clearance between the components of the bearing device constantly in an appropriate value even if the thermal expansion of the components is caused by rising the temperature thereof.

A motor having a rotational member supported rotatably through a bearing device provided on a base member of the motor, said bearing device comprising upper and lower ball bearings each of which includes an inner ring fit around a shaft of the motor, an outer ring, and a plurality of balls interposed therebetween, said bearing device further comprising a spacer interposed between the outer rings of the upper and lower ball bearings wherein the spacer is made of material larger in its coefficient of linear expansion than that of the upper and lower outer rings.

### BACKGROUND OF THE INVENTION

1. Technical Field

The present invention relates to a motor suitable for office automation equipment such as hard disc drive devices of computers.

2. Description of the Prior Art

The motor for driving the magnetic disc or discs of the hard disc drive devices of computers may have for example the structure in which a pair of single row bearing device or ball bearings are used in parallel with each other. In such an structure, the shaft stationary secured on the base member to extend therefrom is provided with a pair of upper and lower ball bearings and a rotor 45 or the rotational member for mounting the magnetic disc or discs is fit over the outer periphery of the ball bearings.

Between inner and outer ring raceways and balls interposed therebetween, there is a radial clearance which is a total of a movement between the outer ring and the inner ring wherein the inner ring is stationary secured and the outer ring is displaced in the radial direction.

It is necessary to retain the amount of the radial clearance in an optimum value in dependence on the size of the bearing device or the application of the motor, since the radial clearance will affect on the service life, the vibration generated, and the quietness of the bearing device.

However, upon rising the temperature of the bearing device under the effect of the frictional heat generated by the rotation or the operation of the bearing device itself or the effect of heat energy supplied from the outside of the bearing device, the thermal expansion of the components of the bearing device will be caused differently. The order of the amount of expansion in the radial direction of the components is that the outer ring>the inner ring>balls.

There is a following relationship between the radial clearance and the dimension of each component of the bearing. (radial clearance)=[inner diameter of the outer ring raceway−(2×diameter of each ball+outer diameter of the inner ring raceway)]

In this connection, upon rising the temperature, the inner diameter of the outer ring raceway will be enlarged to the larger degree than that of the outer diameter of the inner ring raceway formed around the inner ring, and the clearance defined between both ring raceways will also be enlarged. Whereas the degree of enlargement of the balls is small relative to the inner and outer ring raceways so that the radial clearance will be enlarged upon rising the temperature. This will lead to the shortening of the service life of the bearing device. Further, the enlargement of the radial clearance will generate the vibration upon rotation and the noise caused thereby. This also deteriorates the precision or the quietness of the rotation of the motor, and in some cases, this will bring the reduction of the reliability of the equipment such as the hard disc drive means to which the bearing device is to be incorporated.

Although the balls are usually formed of steel material ceramic material may also be used for enhancing the durability thereof. In such a case, the before mentioned problem caused by the difference of the amount of thermal expansion between components will become serious, since the amount of thermal expansion of the ceramic material is further lower (about 1/10) than that of the steel material used for the inner and outer rings.

Accordingly the object of the present invention is to provide a motor including a bearing device wherein an optimum radial clearance can be maintained even if the components thereof expand upon rising the temperature thereof. In other words, the object of the present invention is to provide a motor including a bearing device of high precision in its rotation and long life wherein the vibration upon rotation of the bearing and the noise caused thereby are hard to be caused.

### SUMMARY OF THE INVENTION

In order to attain the object of the present invention, in accordance with the first aspect of the present invention, a motor has a rotational member rotatably supported through a bearing device provided on a base member of the motor, said bearing device comprising upper and lower ball bearings each of which includes an inner ring fit around a shaft of the motor, an outer ring, and a plurality of balls interposed therebetween, said bearing device further including a spacer interposed between the outer rings of the upper and lower ball bearings wherein the spacer is made of material larger in its coefficient of linear expansion than that of the upper and lower outer rings.

A motor in accordance with the second aspect of the present invention has a rotational member supported rotatably through a bearing device provided on a base member thereof, said bearing device comprising;

a stepped shaft including a larger diameter shaft portion around which an inner ring raceway is formed directly thereon and a reduced diameter shaft portion,

a ball bearing including an inner ring fit slidably around the reduced diameter shaft portion and an outer ring,

an outer ring surrounding the inner ring raceway provided around the larger diameter shaft portion,

a plurality of balls interposed between the inner ring raceway and the outer ring raceway formed on the inner peripheral surface of the outer ring, and

a spacer interposed between the outer ring of the ball bearing and the outer ring provided around the larger diameter shaft portion; wherein the spacer is made of material larger in its coefficient of linear expansion than that of the outer rings.

The bearing device may include low expansion rings press fit around the outer periphery of the outer ring, wherein the low expansion rings are made of a material lower in its coefficient of linear expansion than that employed for the outer ring. The balls are preferably of ceramic material, and the low expansion members are preferably also of ceramic material.

### Brief Description of the Drawings

Further feature of the present invention will become apparent to those skilled in the art to which the present invention relates from reading the following specification with reference to the accompanying drawings, in which:

FIG. 1 is an axial sectional view showing the motor of the first embodiment in accordance with the present invention;

FIG. 2 is an axial sectional view showing the bearing device of the motor shown in FIG. 1;

FIG. 3 is an axial sectional view showing the motor of the second embodiment in accordance with the present invention;

FIG. 4 is an axial sectional view showing the bearing device of the motor shown in FIG. 3;

FIG. 5 is an axial sectional view showing the motor of the third embodiment in accordance with the present invention;

FIG. 6 is an axial sectional view showing the bearing device of the motor shown in FIG. 5;

FIG. 7 is an axial sectional view showing the motor of the fourth embodiment in accordance with the present invention;

FIG. 8 is an axial sectional view showing the bearing device of the motor shown in FIG. 7;

### DETAILED DESCRIPTION OF THE PRESENT INVENTION

Motors in accordance with various embodiments of the present invention will now be described in detail on the basis of the concrete examples thereof illustrated in the attached drawings.

<The First Embodiment>

A motor in accordance with the first embodiment of the present invention includes as shown in FIG. 1, a base member 1 including a flange 1a and a stator yoke holder 2 attached to the central portion of the flange. The stator yoke holder 2 includes a bottom plate 2a and a cylindrical rib 2b formed integrally around the outer periphery of the bottom plate with the same material as that of the bottom plate. The cylindrical rib 2b is provided around the outer periphery thereof with stator yokes 4 around which coils 3 for energizing the motor are wound.

A shaft 5 is stationary secured on the central portion of the bottom plate 2a of the stator yoke holder 2 to extend upwardly therefrom. A rotor 8 including a sleeve 9 formed integrally therewith by employing the same material as that of the rotor is fit around the outer periphery of the upper and lower ball bearing 6, 7 mounted around the shaft 5. The rotor 8 or the rotational member of the motor can thus be supported rotatably through the bearings with respect to the base member 1.

A downward flange 8a formed around the outer peripheral portion of the rotor 8 is provided on its inner periphery with magnets 10 in order to face with the outer periphery of the stator yoke with a slight clearance remaining between them.

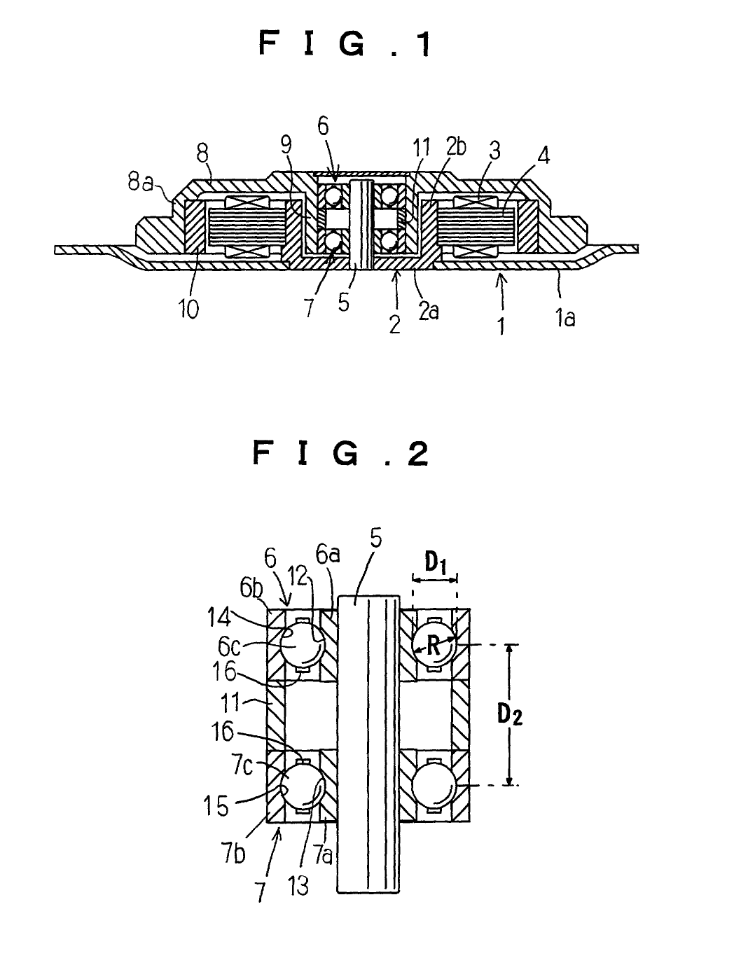

The upper ball bearing 6 includes as shown in the enlarged cross sectional view of FIG. 2, inner and outer rings 6a and 6b, and a plurality of balls 6c of steel or ceramic material interposed therebetween. The lower ball bearing 7 also includes as shown in FIG. 2, inner and outer rings 7a and 7b, and a plurality of balls 7c of steel or ceramic material interposed therebetween.

The outer rings 6b and 7b are spaced from each other by a spacer 11 interposed therebetween. The end faces of the outer rings 6b and 7b and the spacer to be contact with each other are machined in high precision in order to contact intimately with each other. The bearing device is formed by assembling the upper and lower ball bearings 6, 7 and the spacer 11 around the shaft 5 with applying an appropriate pre-load on the shaft through either of the upper or lower inner rings 6a, 7a.

The inner and outer diameters of the upper and lower outer rings 6b, 7b are the same as those of the spacer 11, so that the bearing device having an outer peripheral surface of straight cylindrical configuration equal in its inner and outer diameters can be obtained. The elements of the ball bearing device to which reference numeral 12, 13 are added are the upper and lower inner ring raceways formed of grooves. The elements of the ball bearing device to which reference numeral 14, 15 are added are the upper and lower outer ring raceways. The element of the ball bearing device to which reference numeral 16 is added is a ball retainer.

The spacer used in the bearing device of the present invention is made of material larger in its coefficient of linear expansion than that of the upper and lower outer rings.

To give an example, the outer rings 6b and 7b are formed of steel material such as high carbon chromium bearing steel or stainless steel, whereas the spacer 11 is formed of aluminum or synthetic resin larger in their coefficient of linear expansion than that of steel material.

Upon rising the temperature of the bearing device or each element thereof under the effect of the frictional heat generated by the rotation or the operation of the motor or the effect of heat energy supplied from the outside of the motor, the thermal expansion of each element of the bearing device will be caused. The amount of expansion of the outer ring is larger than that of the inner ring so that the spacing D₁ defined between the inner and outer ring raceways of the ball bearing tends to enlarge under the effect of heat. The amount of the enlargement of the spacing D₁ is larger than the amount of expansion of the diameter R of the balls so that the radial clearance will be enlarged.

Whereas, in the bearing device of the present invention, the spacer 11 tends to expand in the axial direction upon rising the temperature of the bearing device, and the spacing defined between the upper and lower outer rings 6b and 7b or the spacing D₂ defined between the outer ring raceways 14 and 15 is enlarged accordingly, thus both outer ring raceways will displace relative to each ball in order to reduce the radial clearance.

In this connection, the enlargement of the radial spacing due to the enlargement of the spacing D₁ between inner and outer ring raceways of each bearing under the effect of the thermal expansion in the radial direction of the inner and outer rings will be offset by the reduction of the radial spacing due to the enlargement of the spacing D₂ defined between the upper and lower outer ring raceways 14 and 15. Thus the radial spacing can be kept constantly in an appropriate value so that the steady rotation can also be obtained.

<The Second Embodiment>

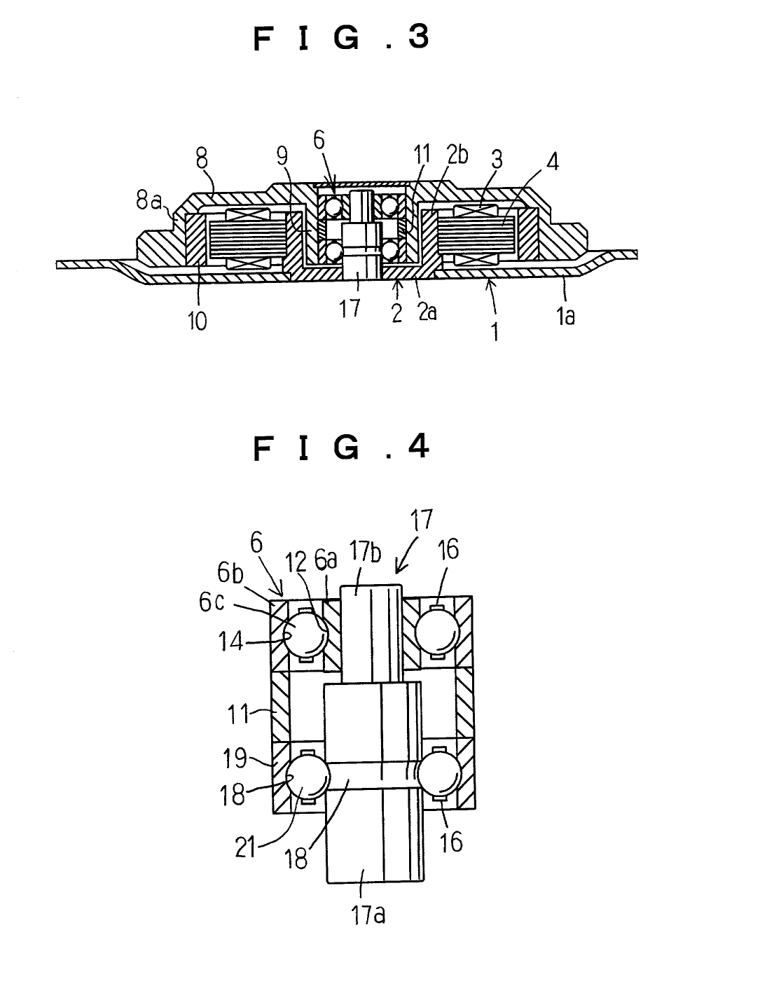

The bearing device of the motor of the second embodiment in accordance with the present invention comprises as shown in FIGS. 3, 4, a stepped shaft 17 including a larger diameter shaft portion 17a and a reduced diameter shaft portion 17b, and an inner ring 6a of the ball bearing 6 fit around the reduced diameter shaft portion 17b of the stepped shaft. The larger diameter shaft portion 17a includes an inner ring raceway 18 formed directly around the outer periphery thereof.

The lower outer ring 19 is provided around the larger diameter shaft portion 17a, and a plurality of balls 21 of steel or ceramic material for the lower row are disposed between the lower outer ring raceway 20 formed on the inner peripheral surface of the outer ring 19 and the lower inner ring raceway 18.

The bearing device of the motor of the second embodiment in accordance with the present invention is also provided with the spacer 11 formed for example of aluminum or synthetic resin larger in their coefficient of linear expansion than the outer ring.

The outer diameter of the inner ring 6a is the same as that of the enlarged outer diameter stepped portion 17a of the stepped shaft. The upper and lower outer rings 6b, 19 are equal in their inner diameter, so that the balls equal in their diameter can be used in both of the upper and lower rows.

In the before mentioned bearing device of the motor of the second embodiment, the lower inner ring race way is formed directly on the outer periphery of the larger diameter shaft portion 17a of said stepped shaft so that no inner ring is required in the lower row. In this connection, the number of parts can be reduced, the diameter of the larger diameter shaft portion 17a can be enlarged by the thickness of the inner ring of the ball bearing, i.e. a generally thick stepped shaft can be obtained.

Accordingly, the stepped shaft 17 of higher rigidity, good at durability, inhibited in its rotational run out, and good at quietness can be obtained. Thus the motor of higher durability and precision of rotation can be obtained.

The bearing device of the second embodiment is substantially identical with the first embodiment, and the components or arrangements other than the bearing device of the motor are identical with those of the first embodiment.

<The Third Embodiment>

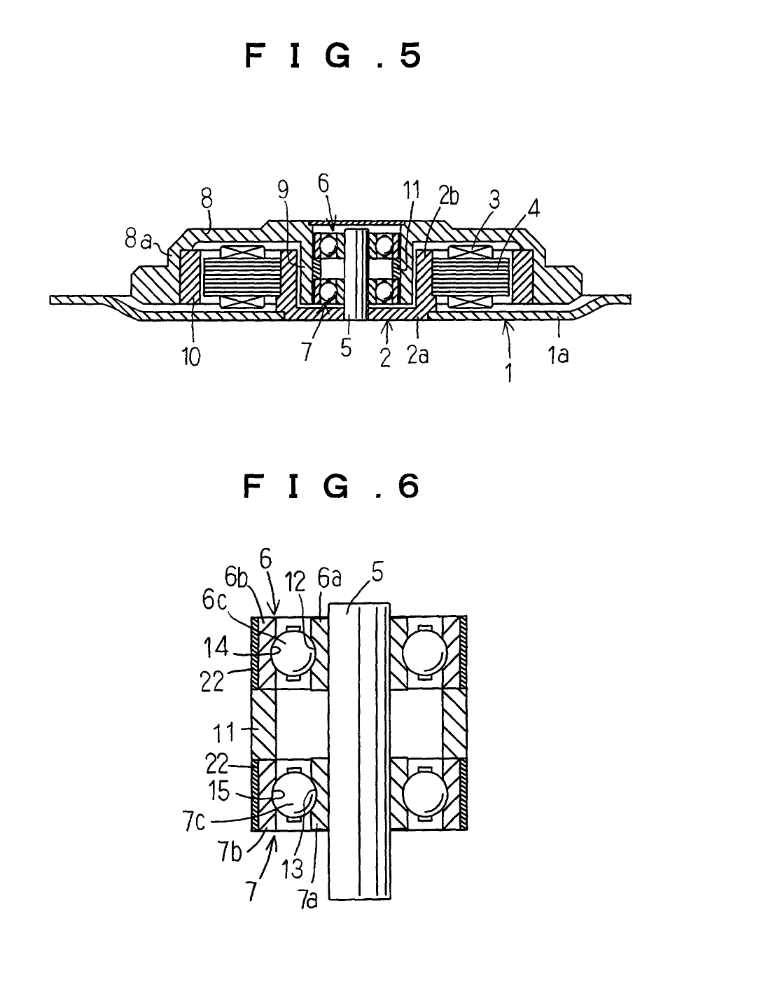

The bearing device of the motor of the third embodiment as shown in FIGS. 5, 6 can be differentiated from that of the first one as shown in FIGS. 1, 2 in that the low expansion rings 22, 22 are press fit around the outer periphery of the upper and lower outer rings 6b, 7b of the bearing device to inhibit the expansion of the outer rings 6b, 7b in radial direction in order to suppress the amount of expansion of the outer ring raceways 14, 15. The coefficient of expansion of the low expansion rings is lower than that of the outer rings 6b, 7b.

In other words, the amount of expansion of the inner diameter of the outer ring raceway to the amount substantially equal to the amount of expansion of the outer diameter of the inner ring raceway to keep the spacing between both rolling contact grooves substantially constant by setting the pressure to be applied on the outer ring through said low expansion ring 22 in an appropriate value. Thus the radial spacing can be maintained in an appropriate value.

It is most suitable to form the low expansion ring 22 of a ceramic material of lower coefficient of linear expansion than steel material. The ratio of the coefficient of linear expansion of the ceramic material to that of the steel material is approximately 1/1.5-⅓.

In the bearing device of the motor of the third embodiment, even if the coefficient of linear expansion of the spacer is only slightly different from that of the outer ring, the radial clearance can be maintained in an appropriate value, and stable rotation of the bearing device can be obtained, since the expansion of the outer ring in radial direction is suppressed by the low expansion ring.

The outer diameter of the low expansion ring 22 is substantially identical with that of the spacer 11 so that the bearing device having an outer peripheral surface of straight cylindrical configuration equal in its outer diameter can be obtained.

The bearing device of the third embodiment is substantially identical with the first embodiment, and the components or arrangements other than the bearing device of the motor are identical with those of the first embodiment.

<The Fourth Embodiment>

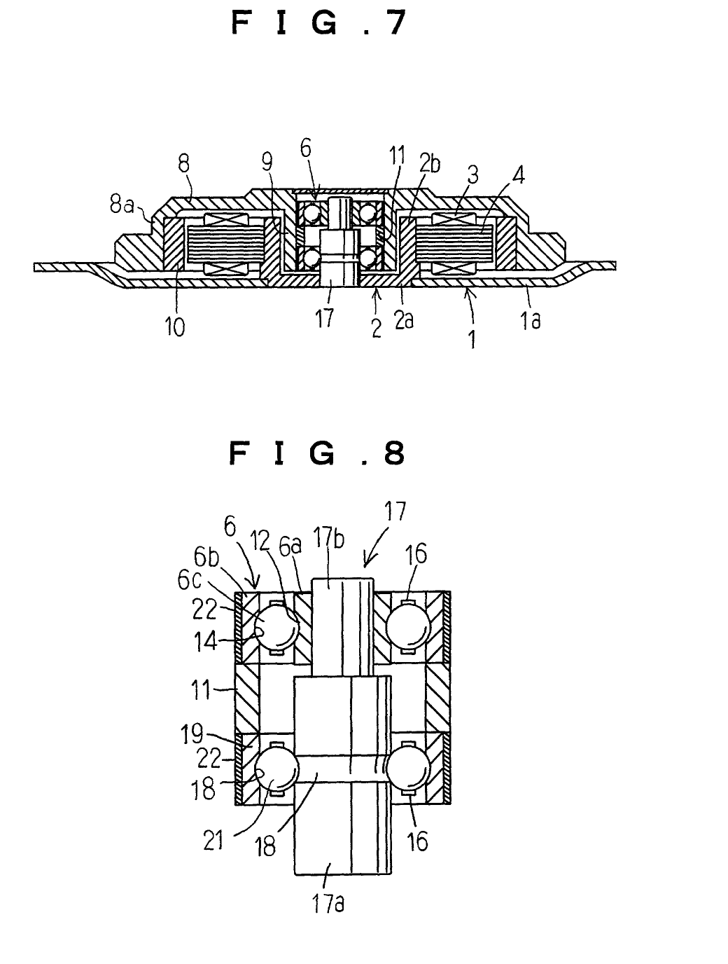

The bearing device of the motor of the fourth embodiment as shown in FIGS. 7, 8 can be differentiated from that of the second one as shown in FIGS. 3, 4 in that the low expansion rings 22, 22 are press fit around the outer periphery of the upper and lower outer rings 6b, 19 of the bearing device in a same manner as that effected in the third embodiment mentioned before to inhibit the expansion of the outer rings 6b, 19 in radial direction in order to suppress the amount of expansion of the outer ring raceways 13, 20. The coefficient of expansion of the low expansion rings is lower than that of the outer rings 6b, 19.

The bearing device of the fourth embodiment is substantially identical with that of the second embodiment, and the components or arrangements other than the low expansion rings 22 are identical with those of the second embodiment.

The motors of all embodiments mentioned before are of the outer rotor type in which the shaft of the motor is stationary secured. However, the motor of shaft rotating type in which the sleeve outer ring or the outer ring member of the compound bearing device is connected to the base member, and the rotating member is connected to the shaft can also be used. Further, a motor of the inner rotor type in which the rotor magnets are provided on the inside of the stator yoke can also be used.

The motor of the arrangement or the structure as described before in accordance with the present invention will provide the following effects.

The bearing device of the motor of the present invention includes a spacer made of aluminum or synthetic resin larger in its coefficient of linear expansion than that of the outer ring of the bearing device. The spacer is interposed between the upper and lower outer rings. Upon rising the temperature of the motor, the components of the bearing device expand to enlarge the radial clearance, the spacer also expand or extend thermally in the axial direction to displace the upper and lower outer rings from each other to enlarge the spacing between the outer rings raceways. Thus the outer rings raceways is adapted to be displaced relative to the balls to reduce the radial clearance to maintain the pre-load to be applied on the balls in an appropriate value.

The diametric expansion of the outer ring member can be constrained by the low expansion ring press fit around the outer peripheral surface thereof even if the thermal expansion of the components of the bearing device will be caused upon rising the temperature of the bearing device, since the low expansion ring is formed of a material of lower coefficient of linear expansion than that of the material used in the outer ring member. Thus the amount of expansion of the inner diameter of the outer ring raceways formed on the inner periphery of the outer ring member can also be retained in a relatively lower value. The low expansion ring is formed for example of ceramic material etc.

Thus the radial clearance of the bearing device can be retained in an appropriate value and the accuracy of the rotation can also be kept constantly stable even if the temperature of the bearing device is varied. In this connection, the generation of the rotational run out and noises accompanied therewith can be suppressed.

In the bearing device having the balls of ceramic material, the durability of the balls is higher than the balls of steel so that the bearing device of longer service life can be obtained.

While particular embodiments of the present invention have been illustrated and described, it should be obvious to those skilled in the art that various changes and modifications can be made without departing from the spirit and scope of the invention.

What is claimed is,

1. A motor having a rotational member supported rotatably through a bearing device provided on a base member of the motor, said bearing device comprising upper and lower ball bearings each of which includes an inner ring fit around a shaft of the motor, an outer ring, and a plurality of balls interposed therebetween, said bearing device further comprising;
a spacer interposed between the outer rings of the upper and lower ball bearings wherein the spacer is made of material larger in its coefficient of linear expansion than that of the upper and lower outer rings.

2. A motor having a rotational member suported rotatably through a bearing device provided on a base member thereof, said bearing device comprising;
a stepped shaft including a larger diameter shaft portion around which an inner ring raceway is formed directly thereon and a reduced diameter shaft portion,
a ball bearing including an inner ring fit slidably around the reduced diameter shaft portion, and an outer ring,
an outer ring surrounding the inner ring raceway provided around the larger diameter shaft portion,
a plurality of balls interposed between the inner ring raceway and the outer ring raceway formed on the inner peripheral surface of the outer ring, and
a spacer interposed between the outer ring of the ball bearing and the outer ring provided around the larger diameter shaft portion; wherein the spacer is made of material larger in its coefficient of linear expansion than that of the outer rings.

3. The motor according to claim 1, characterized in that low expansion rings made of material lower in its coefficient of linear expansion than that of the outer rings are press fit around the outer periphery of each outer ring of the bearing device respectively.

4. The motor according to claim 2, characterized in that low expansion rings made of material lower its coefficient of linear expansion than that of the outer rings are press fit around the outer periphery of each outer ring of the bearing device respectively.

5. The motor according to claim 3, characterized in that the low expansion rings of the bearing device are made of ceramic material.

6. The motor according to claim 4, characterized in that the low expansion rings of the bearing device are made of ceramic material.

7. The motor according to claim 1, characterized in that the balls of the bearing device are made of ceramic material.

8. The motor according to claim 2, characterized in that the balls of the bearing device are made of ceramic material.
